(19) United States
(12) Patent Application Publication
(10) Pub. No.: US 2025/0360572 A1
(43) Pub. Date: Nov. 27, 2025

(54) FLAT DRILL

(71) Applicant: Gühring KG, Albstadt (DE)

(72) Inventor: Christine RIESTER, Sigmaringen (DE)

(73) Assignee: Gühring KG, Albstadt (DE)

(21) Appl. No.: 19/181,285

(22) Filed: Apr. 16, 2025

(30) Foreign Application Priority Data
Apr. 18, 2024 (DE) 10 2024 110 944.0

(51) Int. Cl. B23B 51/02

(52) U.S. Cl. CPC B23B 51/02; B23B 2251/14; B23B 2251/18

(57) ABSTRACT

A flat drill (1) with a shank (6) and a cutting part (8) with front-side main cutting edges (16), which each extend in a plane transversely to the drill axis (3) from a cutting edge corner (22) into the drill center. The flat drill (1) has exactly three main cutting edges (16), which converge at the drill axis (3).

### CROSS-REFERENCE TO A RELATED APPLICATION

This application claims the benefit under 35 U.S.C. 119 sections (a)-(d) of German Patent Application DE 10 2024 110 944.0, filed Apr. 18, 2024, the entirety of which is incorporated herein by reference.

### DESCRIPTION

The invention relates to a flat drill according to the preamble of claim 1.

Flat drills of this type are used in many ways. They extend along a longitudinal central axis or drill axis, respectively, and have a shank as well as a cutting part. The cutting part usually has two cutting webs, which each form a cutting wedge with a main cutting edge. The main cutting edge of the cutting wedge is thereby formed of cutting line of a chip surface, via which the chip runs out into a chip flute, which runs along the flat drill, in particular helically at an angle of twist, and a free surface. Flat drills of the mentioned type are characterized in that the main cutting edges are arranged at a tip angle of 180° relative to one another. The main cutting edges thus lie in one plane. In contrast to drills, the tip angle of which is smaller than 180° and which form a borehole with conical base when drilling into a workpiece, blind holes with flat hole base can be generated by means of a flat drill. The main cutting edges in each case run radially outwards all the way to a cutting edge corner, where they merge into a secondary cutting edge, which is provided for the finishing of the bore and which is adjoined by a guide bevel in the circumferential direction of the drill. The main cutting edges can be connected to one another via a cross cutting edge in the region of the drill center. Alternatively, a central center tip or a centering section, respectively, can be provided, which simplifies the drilling when drilling into solid.

A flat drill formed as spiral drill with two main cutting edges and two chip flutes, which extend helically along a longitudinal central axis, is thus known, for example, from the EP 1 748 859 B1. The two main cutting edges form a common continuous cutting edge, which is connected via a cross cutting edge and which runs in a plane perpendicular to the longitudinal central axis. The two main cutting edges are thus oriented relative to one another at an angle of 180°, which results in a borehole base, which is completely flat and planar. The main cutting edges are formed in a straight line and lie essentially on one line-except for a small offset caused by the cross cutting edge. For the correction of the chip angle of the main cutting edge, a point thinning is provided in terms of a reliable chip removal, which point thinning defines the chip surface adjoining the main cutting edge and which extends over the entire length of the main cutting edge, i.e., from the cross cutting edge all the way to the cutting edge corner. As a function of the material to be drilled, a chip angle between −8° to +10° is set. A negative chip angle of the main cutting edge generates a scraping cut and can increase the stability of the drill but can degrade, for example, the centering in the workpiece. A positive chip angle can simplify the centering of the drill but can lead to a more unstable main cutting edge.

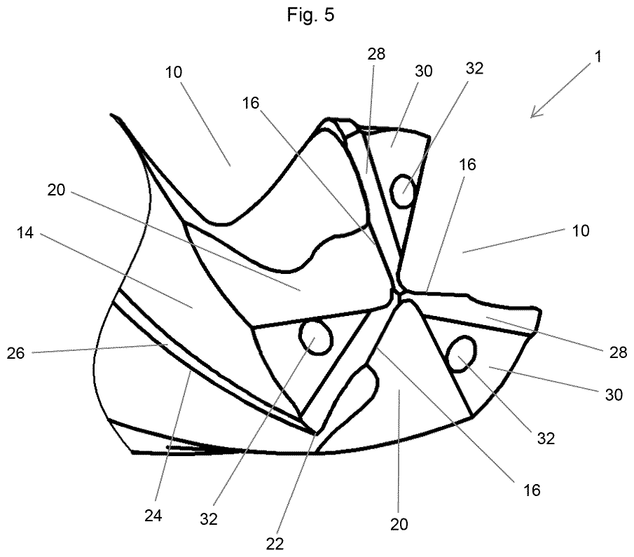

In FIG. 5, the publication DE 10 2007 040 178 B4 proposes a flat drill with two main cutting edges, which are point-symmetrical with respect to a longitudinal central axis of the drill and which in each case extend from a cutting edge corner all the way to a cross cutting edge. The flat drill has a flattening, which shortens the cross cutting edge and which changes the course of the main cutting edges in a central region of the flat drill so that center cutting edges are created, which extend all the way to the cross cutting edge, starting at the originally existing main cutting edges. The main cutting edges and center cutting edges each have two angled free surfaces as well as a chip surface. In the embodiment shown in FIG. 5 of the DE 10 2007 040 178 B4, the main cutting edges and center cutting edges lie in a plane, which is perpendicular to a longitudinal central axis, so that a tip angle of 180° results. Viewed in the direction of rotation of the drill, the main cutting edges each lie approx. 5% to 15% in front of a plane, which contains the longitudinal central axis and the respective cutting edge corner.

In the field of flat drills, there is generally a need for increasing the stability of the flat drills and thus the service life thereof. It is desirable at the same tine to better center the flat drill and to improve the chip removal.

Based on the flat drill shown in the EP 1 748 859 B1, the invention is thus based on the object of providing a flat drill, which has an increased service life, can be centered more easily and improves the chip removal.

This object can be solved by means of a flat drill with the features of claim 1. The subclaims relate to advantageous designs.

The flat drill has a shank and a cutting part with front-side main cutting edges, which each extend in a plane transversely to the drill axis from a cutting edge corner into the drill center. The flat drill can have three main cutting edges, which converge at the drill axis.

In the usual way, the flat drill can thus have an, in particular cylindrical, shank and a cutting part, along the longitudinal central or axis drill axis of which, respectively, three chip flutes assigned to the three main cutting edges extend, in particular helically at an angle of twist. A web, which forms a cutting wedge on a front side of the flat drill, can extend in parallel and adjacent to each chip flute. The cutting wedge is defined by a chip surface and a free surface, the cutting line of which is formed by the main cutting edge. An angle formed between the chip surface of the main cutting edge and a tool reference plane, which is perpendicular to a processing surface, is referred to as axial chip angle. The chip angle can be positive, 0° or negative and has an impact, for example, on the processed surface, the chip flow, the cutting force and friction between the drill and the workpiece to be processed. An angle formed between the free surface and a cutting edge plane corresponding to the processing surface is referred to as clearance angle. Large clearance angles can reduce the friction between the flat drill and the workpiece but decrease the wedge angle and can thus increase the wear. Small clearance angles can stabilize the cutting wedge and can reduce the wear but increase the friction between the spiral drill and the workpiece. The sum of chip angle, clearance angle and wedge angle is always 90°. Each main cutting edge extends radially outwards all the way to the cutting edge corner, where it merges into a secondary cutting edge, which is provided for the finishing of the bore and which is adjoined by a guide bevel in the circumferential direction. An angle formed between the chip surface of the secondary cutting edge and a tool reference plane perpendicular to the processing surface is referred to as radial chip angle.

In particular the main cutting edges perform the majority of the chipping work and are thus exposed to the highest stresses. By providing three main cutting edges, the stress is distributed to the three main cutting edges. Compared to conventional flat drills with two main cutting edges, as they are known, for example, from the EP 1 748 859 B1, the stress for each main cutting edge reduces from 50% to 33.33% in the drilling process and thus decreases by 33.33% for each main cutting edge. The durability of the flat drill and thus its service life increases due to the lower stress. The flat drill can furthermore be centered better during the drilling process by means of the additional third main cutting edge, which leads to more precise bores. Lastly, the third main cutting edge provides for faster drilling speeds and for a more efficient chip removal because the additional main cutting edge can break chips and can remove the chip material more quickly, whereby the risk of blockages and an overheating of the flat drill is reduced.

The front-side main cutting edges of the flat drill can extend in a plane, which is perpendicular to the longitudinal central axis or drill axis, respectively, or which lies transversely to the longitudinal central axis or drill axis, respectively, and which converge at the drill axis. The flat drill as a whole is able to drill blind holes with flat hole base into the solid material in a reliable manner and with consistently high quality.

Viewed in the direction of rotation of the drill, the main cutting edges can in each case lie at least partly in front of a plane containing the drill axis and the respective cutting edge corner (this position is referred to as “in front of center” in technical language, while a position behind the afore-mentioned plane is referred to as “behind center”) and the course of the main cutting edges can in each case be corrected by means of a point thinning in the region of the drill core. The main cutting edges can in particular lie in front of center in an inner main cutting edge section, which is designed by the point thinning.

The stability of the drill as well as its tendency to vibrate increases due to the arrangement of the main cutting edges, which in each case lie at least partly in front of a plane, viewed in the direction of rotation of the drill, whereby the drilling quality as a hole increases.

On the one hand, the course of the main cutting edges as well as the chip flutes or the chip angle, respectively, is corrected due to the point thinning of the main cutting edges in the region of the drill core on the one hand. Due to the point thinning, an angled course, viewed in a front view of the flat drill, of each main cutting edge can result, which has a first main cutting edge section, which extends all the way to the beginning of the point thinning, starting at the drill axis, at which the main cutting edges converge in one point, as well as a second main cutting edge section, which is angled to the first main cutting edge section, in the region of the point thinning. Due to the point thinning, the chip angle of each main cutting edge can change so that it is negative or less positive, for example, than without the point thinning. When the chip angle is negative or less positive than without the point thinning, the wedge angle of the cutting wedge and thus the stability of the main cutting edge increases in this region. The tendency of the drill to slip or deviate can reduce, in particular when processing materials, which are hard or which are difficult to process. The risk of a cutting edge break-off is furthermore decreased, whereby the durability of the flat drill increases. Lastly, the flat drill can be operated at higher cutting speeds, which leads to a reduction of the processing time.

In one embodiment, the main cutting edges in each case run in a crescent-shaped manner from the point thinnings in the direction of the cutting edge corners. The main cutting edge section, which runs in a crescent-shaped manner, can lie in front of or behind center.

A crescent-shaped course of the main cutting edge from the point thinning in the direction of the cutting edge corner effects a chip steering in the direction of the drill core, whereby the chip removal is improved, and reduces the friction between the drill and the workpiece to be processed, whereby the heat development and the risk of an overheating and of a cutting edge break is reduced during the drilling process. A crescent-shaped main cutting edge can furthermore contribute to the fact that the flat drill centers better in the workpiece and that no slipping or deviating of the flat drill takes place. As a whole, a flat drill with crescent-shaped main cutting edge can attain a higher drilling quality from the point thinning in the direction of the cutting edge corner with a smoother surface and a lower level of burr formation.

When the main cutting edges of a flat drill are in each case corrected by means of a point thinning and run in a crescent-shaped manner from the point thinning in the direction of the respective cutting edge corner, each main cutting edge can have a first main cutting edge section, which extends all the way to the beginning of the point thinning, starting at the drill axis, at which the main cutting edges converge in one point, a second main cutting edge section, which is angled to the first main cutting edge section, in the region of the point thinning, as well as a third main cutting edge section, which runs in a crescent-shaped manner from the point thinning all the way to the cutting edge corner.

In a further embodiment, the flat drill can have chip surfaces, which adjoin the main cutting edges and which each have a positive axial chip angle in the region from the point thinning all the way to the cutting edge corners.

The chip removal is improved due to the positive axial chip angle, whereby the risk of blockages and overheating of the flat drill reduces. The friction between the main cutting edge and the workpiece can furthermore be reduced, which has a positive impact on the wear. Lastly, the positive axial chip angle can also contribute to the fact that the flat drill remains better centered, which leads to more precise bores.

The chip surfaces, which adjoin the main cutting edges, can each have an axial chip angle of 0° in the region of the point thinnings.

The axial chip angle of 0° increases the wedge angle of the main cutting edge in the region of the point thinning, whereby the stability of the main cutting edge and thus the durability of the flat drill can increase.

In a further embodiment, the flat drill has free surfaces, which adjoin the main cutting edges and which are in each case formed of a first free surface adjoining the main cutting edge and a second free surface adjoining the first free surface with a larger clearance angle than the first free surface. The first and/or second free surfaces can each be surfaces, which are partially ground in a planar manner. Alternatively, the free surfaces adjoining the main cutting edges can also be free surfaces, which are partially ground in a relieved cone-shaped manner.

The clearance angle of the first free surface, which is smaller compared to the clearance angle of the second free surface, provides for a stable cutting wedge and thus reduces wear and vibrations of the flat drill. The larger clearance angle of the second free surface, in contrast, can contribute to reducing the friction of the drill with the workpiece. The two free surfaces can furthermore be re-ground independently of one another.

The flat drill can have cooling lubricant channel exit openings in the free surfaces.

The cooling lubricant channel exit openings can advantageously be arranged in the second free surfaces, which adjoin the first free surfaces. In this way, cooling lubricant can be guided reliably to the main cutting edges on the one hand and the stability of the cutting wedges cannot be impacted by the cooling lubricant channels, which run within the cutting webs on the other hand.

In a further embodiment, the flat drill has chip flutes, which run helically.

Advantageously, an angle of twist, which determines the helical shape of the chip flutes and the process of the chip formation, is selected depending on the application, the material to be processed and the drilling speed. The angle of twist can be selected to be larger, the softer the material, which is to be processed.

Further details, features and advantages follow from the following description of an embodiment on the basis of the drawings, in which:

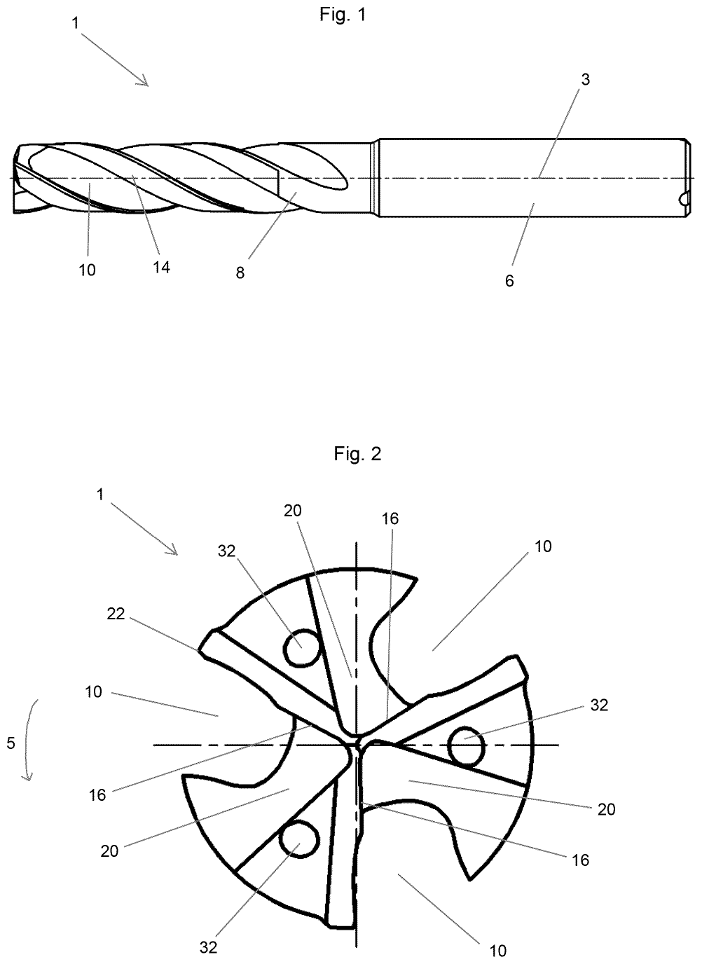

FIG. 1 shows a flat drill according to an embodiment in a side view;

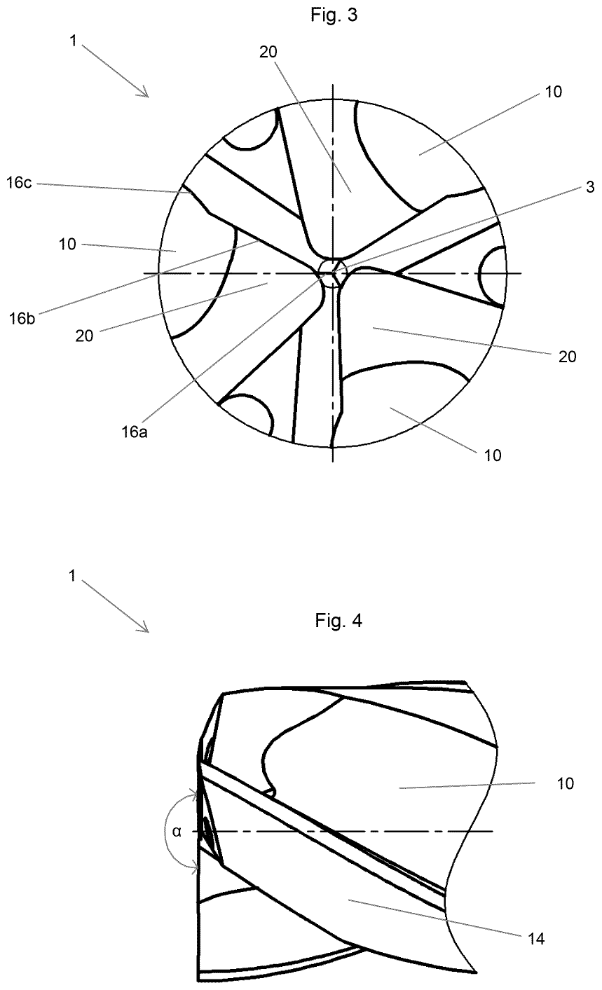

FIG. 2 shows a front view of the flat drill from FIG. 1;

FIG. 3 shows a detailed view of the flat drill from FIG. 2;

FIG. 4 shows a side view of a cutting part of the flat drill from FIG. 1; and

FIG. 5 shows a perspective view of the flat drill from FIG. 1.

### EMBODIMENT

A right-handed flat drill with three cutting edges of one embodiment, which has a tool shank 6 extending along a drill axis 3 for clamping into a tool chuck as well as a cutting part 8, is identified with reference numeral 1 in FIGS. 1 to 5. The cutting part 8 has three chip flutes 10 running at a positive angle of twist and three webs 14 running parallel to the chip flutes 10 from a drill front in the direction of the tool shank 6. Each web 14 forms a cutting wedge on its front frontal end, which is illustrated on the left in FIG. 1. The cutting wedge has a main cutting edge 16, the course of which is corrected by means of a point thinning 20 in the region of the drill center or of the drill core, respectively. The flat drill 1 of the embodiment thus has exactly three main cutting edges 16, which converge at the drill axis 3, as is shown in FIG. 3.

As can furthermore be seen from FIGS. 2 and 3, each main cutting edge 16 has a first main cutting edge section 16a, which, starting at the drill axis 3, at which the main cutting edges 16 converge in one point, all the way to the beginning of the point thinning 20, a second main cutting edge section 16b, which is angled to the first main cutting edge section 16a, in the region of the point thinning 20, as well as a third main cutting edge section 16c, which runs in a crescent-shaped manner from the point thinning 20 all the way to a cutting edge corner 22 (not shown completely in FIG. 3).

At the cutting edge corner 22, the main cutting edge 16 or the third main cutting edge section 16c, respectively, merges into a secondary cutting edge 24, which is provided for the bore finishing and which is adjoined by a guide bevel 28 in the circumferential direction of the flat drill 1.

The front-side main cutting edges 16 of the flat drill 11, which each have the first main cutting edge section 16a, the second main cutting edge section 16b and the third main cutting edge section 16c, extend in a plane, which is perpendicular to the drill axis 3 or which lies transversely to the drill axis 3, respectively. As shown in particular in FIG. 4, a tip angle α of the flat drill 1 is exactly 180°. It can furthermore be seen from FIG. 2 that the main cutting edges 16, viewed in the direction of rotation 5 of the drill, in each case lie in front of a plane (not shown) (“in front of center”) containing the drill axis 3 and the respective cutting edge corner 22 in the main cutting edge section 16b designed by the point thinning 20, and lie partly behind the plane (not shown) (“behind center”) containing the drill axis 3 and the respective cutting edge corner 22 in the radially outer main cutting edge section 16c due to the crescent-shaped course.

Viewed against the direction of rotation of the flat drill 1, each main cutting edge 16 is adjoined by a first free surface 28, which has a first clearance angle. Against the direction of rotation of the flat drill 1, a second free surface 30 adjoins the first free surface 28, the second clearance angle of which is larger than the first clearance angle of the first free surface 28. As shown in FIGS. 2 and 5, a cooling lubricant channel exit opening 32 for the exit of cooling lubricant for cooling and lubricating the main cutting edges 16 during the drilling process in each case leads into the second free surfaces 30. In the shown embodiment, the first and second free surfaces 28 and 30 are in each case surfaces, which are partly ground in a planar manner.

Viewed in the direction of rotation of the flat drill 1, each main cutting edge 16 is adjoined by a chip surface, which has a positive axial chip angle in the region from the point thinning 20 all the way to the cutting edge corner 22, i.e., in the region of the third main cutting edge section 16c, which runs in a crescent-shaped manner, and an axial chip angle of 0° in the region of the point thinning 20, i.e. in the region of the second main cutting edge section 16b.

By providing exactly three main cutting edges 16, the stress is distributed to the three main cutting edges 16 in the case of the flat drill 1 of the embodiment. Compared to a conventional flat drill with only two main cutting edges, the stress for each main cutting edge 16 reduces from 50% to 33.33% in the drilling process and thus decreases by 33.33% for each main cutting edge. The durability of the flat drill 1 and thus its service life increases due to the lower stress. The flat drill 1 can furthermore be centered better during the drilling process by means of the additional third main cutting edge 16, which leads to more precise bores. Lastly, the third main cutting edge 16 provides for faster drilling speeds and for a more efficient chip removal because the additional main cutting edge 16 can break chips and can remove the chip material more quickly, whereby the risk of blockages and an overheating of the flat drill 1 is reduced.

### LIST OF REFERENCE NUMERALS

α tip angle
1 flat drill
3 drill axis
5 direction of rotation of the drill
6 tool shank
8 cutting part
10 chip flute
14 web
16 main cutting edge
16a first main cutting edge section
16b second main cutting edge section
16c third main cutting edge section
20 point thinning
22 cutting edge corner
24 secondary cutting edge
26 guide bevel
28 first free surface
30 second free surface
32 cooling lubricant channel exit opening

1. A flat drill with a shank and a cutting part with front-side main cutting edges, which each extend in a plane transversely to the drill axis from a cutting edge corner into a drill center, characterized by three main cutting edges, which converge at the drill axis.

2. The flat drill according to claim 1, viewed in the direction of rotation of the drill, the main cutting edges in each case lie at least partly in front of a plane containing the drill axis and the respective cutting edge corner and the course of the main cutting edges is in each case corrected by means of a point thinning in the region of a drill core.

3. The flat drill according to claim 2, wherein the main cutting edges in each case run in a crescent-shaped manner from the point thinnings in the direction of the cutting edge corners.

4. The flat drill according to claim 2, characterized by chip surfaces, which adjoin the main cutting edges and which each have a positive axial chip angle in the region from the point thinning all the way to the cutting edge corners.

5. The flat drill according to claim 2, wherein the chip surfaces, which adjoin the main cutting edges, each have an axial chip angle of 0° in the region of the point thinnings.

6. The flat drill according to claim 1, characterized by free surfaces, which adjoin the main cutting edges and which are in each case formed of a first free surface adjoining the main cutting edge and a second free surface adjoining the first free surface with a larger clearance angle than the first free surface.

7. The flat drill according to claim 6, characterized by cooling lubricant channel exit openings lying in the free surfaces.

8. The flat drill according to claim 1, characterized by helically running chip flutes.
